(19) United States
(12) Patent Application Publication
(10) Pub. No.: US 2006/0006961 A1
(43) Pub. Date: Jan. 12, 2006

(54) Tunable dielectric phase shifters capable of operating in a digital-analog regime

(76) Inventors: L. Sengupta, Ellicott City, MD (US); Cornelis DuToit, Ellicott City, MD (US); A.B. Kozyrev, St. Peterburg (RU); V.N. Osadehy, Leningzadskaia obl. (RU)

Correspondence Address: James S. Finn;C/O William Tucker, 14431 Goliad Dr., Box #8, Malakoff, TX, 75148, US

(21) Appl. No.: 11/155,251

(22) Filed: Jun. 17, 2005

Related U.S. Application Data
(60) Provisional application No. 60/586,438, filed on Jul. 8, 2004.

(51) Int. Cl. H01P 1/18

(52) U.S. Cl. 333/161

(57) ABSTRACT

An embodiment of the present invention provides an apparatus, comprising a multi-tiered cascaded tunable dielectric phase shifter capable of operating in digital-analog regime by at least one cascade operable in an analog regime and at least one cascade operable in a digital regime. The multi-tiered cascaded tunable dielectric phase shifter may be a three tiered cascaded digital-analog phase shifter using broadside coupled lines with resonance terminations containing tunable dielectric film capacitors. The first two cascades of the three tiered cascades may be operable in a digital regime, and the third cascade may be operable in an analog regime and further the digital regime may operate at (0°/180° and 0°/90°) and the analog regime may operate between (0°÷90°), wherein the analog cascade may provide phase states from 0° up to φN−1 and may add the continuous phase shift functionality to the digital cascades of the phase shifter. Also, the tunable dielectric phase shifter may be capable of providing a continuous 360° phase shift with 5% bandwidth and insertion loss of approximately 3 dB without modulation. An embodiment of the present invention provides that a phase shift by the tunable dielectric phase shifter may be enabled by one or more voltage tunable dielectric capacitors which comprises a low loss tunable dielectric material and metallic electrodes with predetermined shape, size, and distance.

### CROSS REFERENCED TO RELATED APPLICATIONS

This application claims the benefit of Provisional Patent Application Ser. No. 60/586,438, filed Jul. 8, 2004 entitled “FERROELECTRIC PHASE SHIFTERS CAPABLE OF OPERATING IN DIGITAL-ANALOG REGIME”.

### BACKGROUND OF THE INVENTION

Up to now tunable dielectric phase shifters were designed as devices in which the tunable elements (tunable dielectric film capacitors) operate in an analog regime and thus provide continuous variation of capacitance (C) under control voltages. It has been demonstrated that a digital regime for tunable dielectric phase shifters may optimize the quality factor. However, if one uses digital control to obtain small steps of phase switching, this would result in a complicated construction and would increase the number of cascades required. Thus, a strong need exists for tunable dielectric phase shifter capable of overcoming these shortcomings.

### SUMMARY OF THE INVENTION

An embodiment of the present invention provides an apparatus, comprising a multi-tiered cascaded tunable dielectric phase shifter capable of operating in digital-analog regime by at least one cascade operable in an analog regime and at least one cascade operable in a digital regime. The multi-tiered cascaded tunable dielectric phase shifter may be a three tiered cascaded digital-analog phase shifter using broadside coupled lines with resonance terminations containing tunable dielectric film capacitors. The first two cascades of the three tiered cascades may be operable in a digital regime, and the third cascade may be operable in an analog regime and further the digital regime may operate at (0°/180° and 0°/90°) and the analog regime may operate between (0°÷90°), wherein the analog cascade may provide phase states from 0° up to φN−1 and may add the continuous phase shift functionality to the digital cascades of the phase shifter. Also, the tunable dielectric phase shifter may be capable of providing a continuous 360° phase shift with 5% bandwidth and insertion loss of approximately 3 dB without modulation.

An embodiment of the present invention a phase shift by the tunable dielectric phase shifter may be enabled by one or more voltage tunable dielectric capacitors which comprises a low loss tunable dielectric material and metallic electrodes with predetermined shape, size, and distance.

In yet another embodiment of the present invention is provided a method, comprising operating a multi-tiered cascaded tunable dielectric phase shifter in the digital-analog regime by at least one cascade operable in an analog regime and at least one other cascade operable in a digital regime. In an embodiment of the present invention the multi-tiered cascaded tunable dielectric phase shifter may be a three tiered cascaded digital-analog phase shifter using broadside coupled lines with resonance terminations containing tunable dielectric film capacitors.

Yet another embodiment of the present invention provides a phase shifter, comprising broadside coupled lines with resonance terminations containing tunable dielectric film capacitors, at least one cascade within the phase shifter operable in an analog regime and at least two cascades operable in a digital regime. This embodiment provides that the at least two cascades operable in a digital regime operates at 0°/180° and 0°/90° and the analog regime operates between 0°÷90° and the phase shifter may be capable of providing a continuous 360° phase shift with 5% bandwidth and insertion loss of approximately 3 dB without modulation.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 illustrates a cascade of a phase shifter and the equivalent circuit of the tunable reflective termination of one embodiment of the present invention;

FIG. 2 illustrates a phase and amplitude response of a tunable resonance reflective termination in analog and digital regimes of one embodiment of the present invention;

FIG. 3 shows the figure of merit of different types of phase shifters as a function of the number of cascades of one embodiment of the present invention;

FIG. 4 shows the tunable dielectric phase shifter of one embodiment of the present invention with no bias; and

FIG. 5 shows experimental characteristics of the digital-analog phase shifter of one embodiment of the present invention under DC bias.

### DETAILED DESCRIPTION

An embodiment of the present invention provides that the parameters of a tunable dielectric (FE) phase shifter (figure of merit, phase error and modulation of insertion losses under control signal) may be improved due to the design of a device operating in the mixed regime, when one cascade operates in an analog and other in a digital regime.

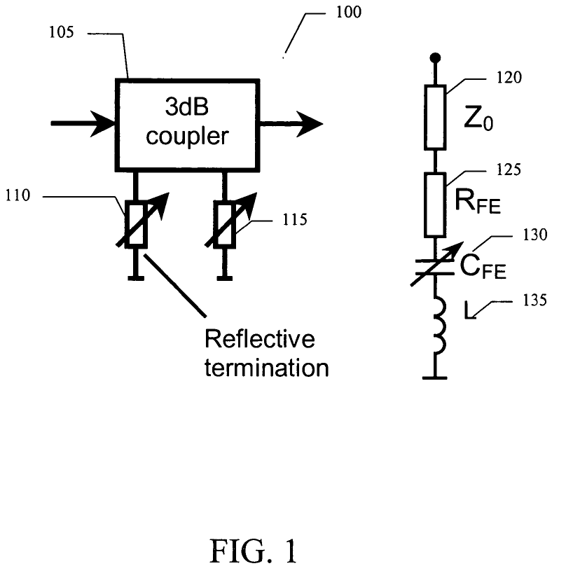

For operation at L, S—band frequencies, one of the most-used principles to design a phase shifter stage is that of a directional coupler 105 loaded by a tunable reflective termination 110 and 115 as shown in FIG. 1, generally as 100. The insertion losses of similar constructions are mainly determined by losses in the reflective terminations 110 and 115. The equivalent circuit of the reflective termination contains the line (characteristic impedance Z0 120) and the resonance LC circuit with the tunable dielectric capacitor CFE 125 and inductor L 135. RFE 125 is the resistance corresponding to the tunable capacitor losses.

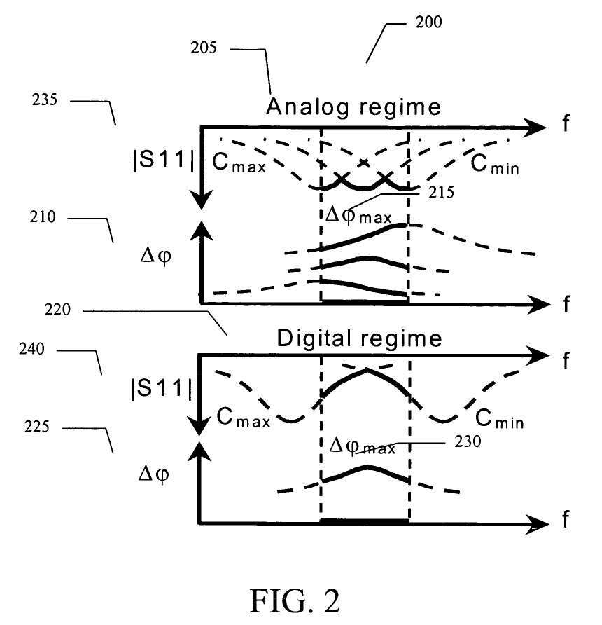

Turning now to FIG. 2 at 200 shown schematically are typical variations of the reflection coefficient (S11) 235 for analog regime and 240 for analog regime and the phase (Δφ) 210 for analog regime and 225 for digital regime for a wave reflected from the single LC resonance termination in an analog 205 and a digital 220 regime. In an analog regime 205, for the case of a continuously tunable tunable dielectric capacitor under control voltage (UC) from Cmax to Cmin this provides the continuous phase variation (0°÷Δφmax) and the maximum of S11 235 curve inevitably crosses the operation frequency range (bold lines in FIG. 2). That in turn results in the increase of loss and its modulation under control voltages.

In a digital regime 220 (0°/Δφmax 230) the maximums of two resonance curves corresponding Cmax and Cmin are located out of the operating frequency range and that leads to the decrease in insertion loss and its modulation under control voltages. Δφmax for the analog regime is illustrated at 215. In order to obtain a small step in phase tuning (Δφmin) using only the digital regime a large number of cascades (N) are needed in accordance with the equation Δφmin=360/2N. This problem may be solved by using a digital-analog regime. This means that one cascade operates in an analog regime and the other in a digital regime. The analog cascade provides phase states from 0° up to φN−1 and adds the continuous phase shift functionality to the digital cascades of the phase shifter. Formulas to estimate the figure of merit (F) of multi-cascaded 360° phase shifters operating in different regimes are presented below:

$${F}^{D} = {[ {\sum }_{n = 1}^{N} \frac{{L}_{n}^{D}}{{Δφ}_{n}^{D} \cdot {2}^{n}} ]}^{- 1}$$

$${F}^{A} = \frac{{Δφ}_{n}^{A}}{{L}_{n}^{A}} = \frac{360}{N \cdot {L}_{n}^{A}}$$

$${F}^{DA} = {[ {\sum }_{n = 1}^{N} \frac{{L}_{n}^{D}}{{Δφ}_{n}^{D} \cdot {2}^{n}} + \frac{{L}_{n}^{A}}{{Δφ}_{n}^{A} \cdot {2}^{N - 1}} ]}^{- 1} .$$

The designations “D”, “A”, “DA” correspond to digital, analog and digital-analog regimes respectively, Δφn and Ln are the phase shift and insertion losses of n-cascade. Note, the equation for FA is obtained for a phase shifter containing identical cascades.

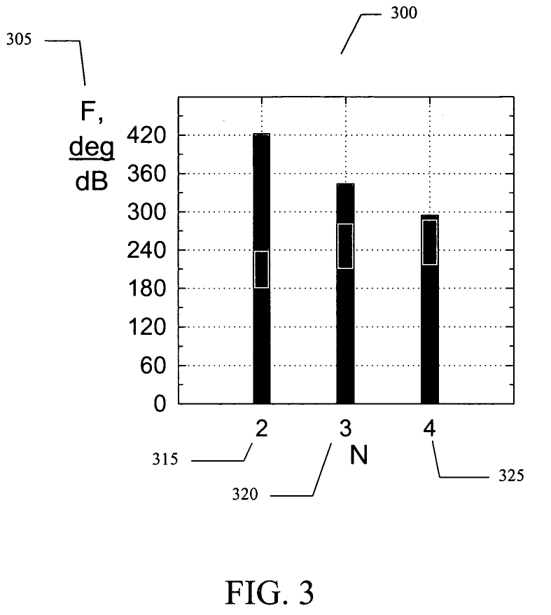

Looking now at FIG. 3, generally at 300 is graphically demonstrated the results of the calculation of F for phase shifters containing a different number of cascades, which are identical to the cascade presented in FIG. 1. The calculation was done for a device with an operating frequency of f=2 GHz that incorporates tunable dielectric film planar capacitors with tunability K=Cmax/Cmin=2 and loss factor tanδ(2 GHz)=0.02. It is understood that the present invention is not limited to the a particular frequency and 2 GHz is used herein for illustrative purposes only. Although tunable capacitors may be obtained with a better quality factor, these parameters were used for the illustration of optimized phase shifter performance from one embodiment of the present invention, and it is understood that the present invention is not limited in this respect. One can conclude that the value associated with the parameter, F 305, has an optimal number of cascades for an analog or a digital-analog device that is not more than N˜(3−4) due to saturation of F(N) dependencies for both regimes. N values of 2 (315), 3 (320) and 4 (325) are depicted herein, however it is understood that these are for illustrative purposes only and the present invention is not limited by these values for N. FIG. 3 demonstrates ˜30% gain of figure of merit may be obtained in the digital-analog regime in comparison with analog one.

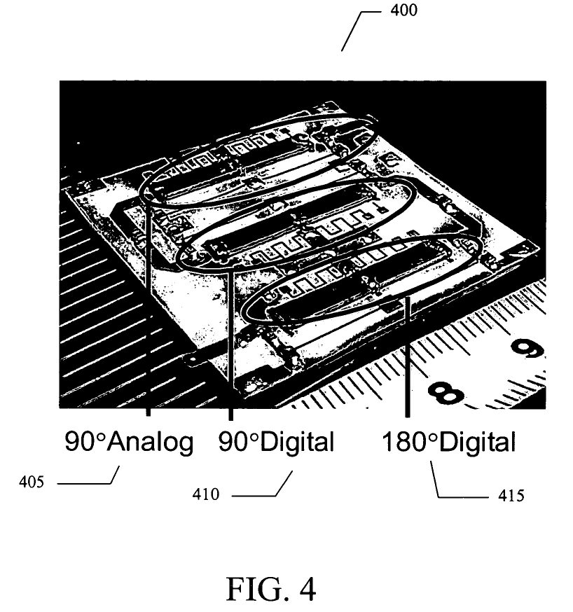

In FIG. 4, generally at 400, is illustrated an embodiment of the present invention which provides a multi (such as 3) tiered cascaded digital-analog phase shifter using broadside coupled lines with resonance terminations containing tunable dielectric film capacitors. The first two cascades 410 and 415 operate in a digital regime (0°/180° and 0°/90°), and the third cascade 405 is analog (0°+90°).

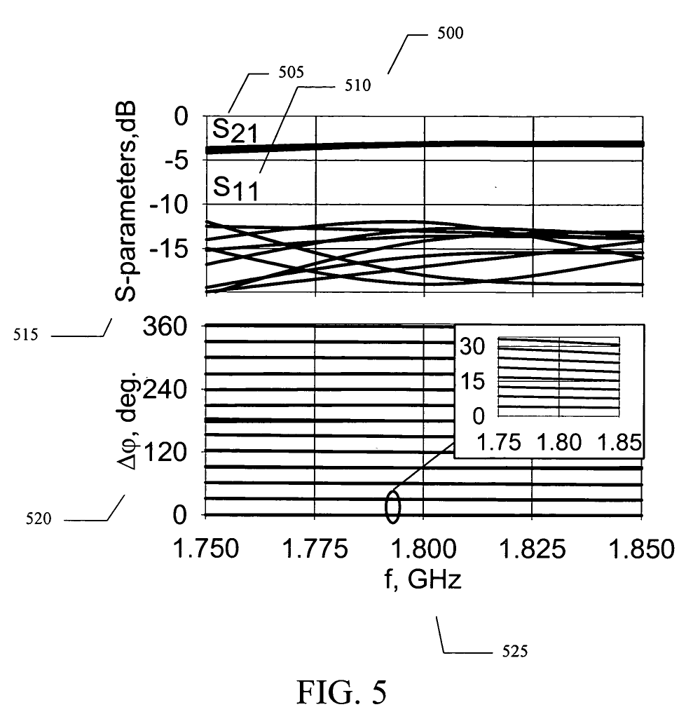

The experimental characteristics of an embodiment of the present invention is provided in FIG. 5 at 500 with x axis 525 in frequency GHz and Y axis in phase shift error 520 and S-parameters in dB 515. S11 is depicted at 510. The device may provide continuous 360° phase shift with 5% bandwidth and demonstrates insertion loss S21 (505)˜3 dB practically without modulation under control voltages (ΔS21(UC)=±0.1 dB). The phase shift error 520 is not more than Δφerror=±2° for all states of controlling voltages. Taking into account that phase resolution is defined by phase error, this device has phase error that is equivalent to a 6-bit digital phase shifter.

To achieve the maximum value of the figure of merit and to minimize the phase error for phase shifters based on tunable dielectric capacitors with typical parameters, the use of a combination of digital and analog cascades may be beneficial. The testing of a 3 tiered cascaded digital-analog tunable dielectric phase shifter based on this principle demonstrates continuous 360° phase tuning with +2° error and a figure of merit 120 deg/dB.

The tunable dielectric capacitor in the present invention may be made from low loss tunable dielectric material. The range of Q factor of the tunable dielectric capacitor is between 50, for very high tuning material, and 300 or higher, for low tuning material. It also decreases with increasing the frequency, but even at higher frequencies, say 30 GHz, may take values as high as 100. A wide range of capacitance of the tunable dielectric capacitors is available, from several pF to several μF. The tunable dielectric capacitor may be a two-port component, in which the tunable dielectric material may be sandwiched between two specially shaped parallel electrodes. An applied voltage produces an electric field across the tunable dielectric, which produces an overall change in the capacitance of the tunable dielectric capacitor.

Tunable dielectric materials have been described in several patents. Barium strontium titanate (BaTiO.sub.3--SrTiO.sub.3), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,427,988 by Sengupta, et al. entitled “Ceramic Ferroelectric Composite Material-BSTO—MgO”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO—ZnO”; U.S. Pat. No. 6,074,971 by Chiu et al. entitled “Ceramic Ferroelectric Composite Materials with Enhanced Electronic Properties BSTO—Mg Based Compound-Rare Earth Oxide”. These patents are incorporated herein by reference.

Barium strontium titanate of the formula Ba.sub.xSr.sub.1-xTiO.sub.-3 is a preferred electronically tunable dielectric material due to its favorable tuning characteristics, low Curie temperatures and low microwave loss properties. In the formula Ba.sub.xSr.sub.1-xTiO.sub.3, x can be any value from 0 to 1, preferably from about 0.15 to about 0.6. More preferably, x is from 0.3 to 0.6.

Other electronically tunable dielectric materials may be used partially or entirely in place of barium strontium titanate. An example is Ba.sub.xCa.sub.1-xTiO.sub.3, where x is in a range from about 0.2 to about 0.8, preferably from about 0.4 to about 0.6. Additional electronically tunable ferroelectrics include Pb.sub.xZr.sub.1-xTiO.sub.3 (PZT) where x ranges from about 0.0 to about 1.0, Pb.sub.xZr.sub.1-xSrTiO-.sub.3 where x ranges from about 0.05 to about 0.4, KTa.sub.xNb.sub.1-xO.sub.3 where x ranges from about 0.0 to about 1.0, lead lanthanum zirconium titanate (PLZT), PbTiO.sub.3, BaCaZrTiO.sub.3, NaNO.sub.3, KNbO.sub.3, LiNbO.sub.3, LiTaO.sub.3, PbNb.sub.2O.sub.6, PbTa.sub.2O.sub.6, KSr(NbO.sub.3) and NaBa.sub.2(NbO.sub.3).sub.5 KH.sub.2- PO.sub.4, and mixtures and compositions thereof. Also, these materials can be combined with low loss dielectric materials, such as magnesium oxide (MgO), aluminum oxide (Al.sub.2O.sub.3), and zirconium oxide (ZrO.sub.2), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. patent applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. provisional application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl.sub.2O.sub.4, MgTiO.sub.3, Mg.sub.2SiO.sub.4, CaSiO.sub.3, MgSrZrTiO.sub.6, CaTiO.sub.3, Al.sub.2O.sub.3, SiO.sub.2 and/or other metal silicates such as BaSiO.sub.3 and SrSiO.sub.3. The non-tunable dielectric phases may be any combination of the above, e.g., MgO combined with MgTiO.sub.3, MgO combined with MgSrZrTiO.sub.6, MgO combined with Mg.sub.2SiO.sub.4, MgO combined with Mg.sub.2SiO.sub.4, Mg.sub.2SiO.sub.4 combined with CaTiO.sub.3 and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO.sub.3, BaZrO.sub.3, SrZrO.sub.3, BaSnO.sub.3, CaSnO.sub.3, MgSnO.sub.3, Bi.sub.2O.sub.3/2SnO.sub.2, Nd.sub.2O.sub.3, Pr.sub.7O.sub.11, Yb.sub.2O.sub.3, Ho.sub.2O.sub.3, La.sub.2O.sub.3, MgNb.sub.2O.sub.6, SrNb.sub.2O.sub.6, BaNb.sub.2O.sub.6, MgTa.sub.2O.sub.6, BaTa.sub.2O.sub.6 and Ta.sub.2O.sub.3.

Thick films of tunable dielectric composites can comprise Ba.sub.1-xSr.sub.xTiO.sub.3, where x is from 0.3 to 0.7 in combination with at least one non-tunable dielectric phase selected from MgO, MgTiO.sub.3, MgZrO.sub.3, MgSrZrTiO.sub.6, Mg.sub.2SiO.sub.4, CaSiO.sub.3, MgAl.sub.2O.sub.4, CaTiO.sub.3, Al.sub.2O.sub.3, SiO.sub.2, BaSiO.sub.3 and SrSiO.sub.3. These compositions can be BSTO and one of these components or two or more of these components in quantities from 0.25 weight percent to 80 weight percent with BSTO weight ratios of 99.75 weight percent to 20 weight percent.

The electronically tunable materials can also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg.sub.2SiO.sub.4, CaSiO.sub.3, BaSiO.sub.3 and SrSiO.sub.3. In addition to Group 2A metals, the present metal silicates may include metals from Group 1A, i.e., Li, Na, K, Rb, Cs and Fr, preferably Li, Na and K. For example, such metal silicates may include sodium silicates such as Na.sub.2SiO.sub.3 and NaSiO.sub.3-5H.sub.2O, and lithium-containing silicates such as LiAlSiO.sub.4, Li.sub.2SiO.sub.3 and Li.sub.4SiO.sub.4. Metals from Groups 3A, 4A and some transition metals of the Periodic Table may also be suitable constituents of the metal silicate phase.

Additional metal silicates may include Al.sub.2Si.sub.2O.sub.7, ZrSiO.sub.4, KalSi.sub.3O.sub.8, NaAISi.sub.3O.sub.8, CaAl.sub.2Si.sub.2O.sub.8, CaMgSi.sub.2O.sub.6, BaTiSi.sub.3O.sub.9 and Zn.sub.2SiO.sub.4. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides.

Preferred additional metal oxides include Mg.sub.2SiO.sub.4, MgO, CaTiO.sub.3, MgZrSrTiO.sub.6, MgTiO.sub.3, MgAl.sub.2O.sub.4, WO.sub.3, SnTiO.sub.4, ZrTiO.sub.4, CaSiO.sub.3, CaSnO.sub.3, CaWO.sub.4, CaZrO.sub.3, MgTa.sub.2O.sub.6, MgZrO.sub.3, MnO.sub.2, PbO, Bi.sub.2O.sub.3 and La.sub.2O.sub.3. Particularly preferred additional metal oxides include Mg.sub.2SiO.sub.4, MgO, CaTiO.sub.3, MgZrSrTiO.sub.6, MgTiO.sub.3, MgAl.sub.2O.sub.4, MgTa.sub.2O.sub.6 and MgZrO.sub.3.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

In one embodiment, the additional metal oxide phases may include at least two Mg-containing compounds. In addition to the multiple Mg-containing compounds, the material may optionally include Mg-free compounds, for example, oxides of metals selected from Si, Ca, Zr, Ti, Al and/or rare earths. In another embodiment, the additional metal oxide phases may include a single Mg-containing compound and at least one Mg-free compound, for example, oxides of metals selected from Si, Ca, Zr, Ti, Al and/or rare earths. The high Q tunable dielectric capacitor utilizes low loss tunable substrates or films.

To construct a tunable device, the tunable dielectric material can be deposited onto a low loss substrate. In some instances, such as where thin film devices are used, a buffer layer of tunable material, having the same composition as a main tunable layer, or having a different composition can be inserted between the substrate and the main tunable layer. The low loss dielectric substrate can include magnesium oxide (MgO), aluminum oxide (Al.sub.2O.sub.3), and lanthium oxide (LaAl.sub.2O.sub.3).

When the bias voltage or bias field is changed, the dielectric constant of the voltage tunable dielectric material (di-elect cons.sub.r) will change accordingly, which will result in a tunable varactor. Compared to semiconductor varactor based tunable filters, the tunable dielectric capacitor based tunable filters of this invention have the merits of lower loss, higher power-handling, and higher IP3, especially at higher frequencies (>10 GHz). It is observed that between 50 and 300 volts a nearly linear relation exists between Cp and applied Voltage.

In microwave applications the linear behavior of a dielectric varactor is very much appreciated, since it will assure very low Inter-Modulation Distortion and consequently a high IP3 (Third-order Intercept Point). Typical IP3 values for diode varactors are in the range 5 to 35 dBm, while that of a dielectric varactor is greater than 50 dBm. This will result in a much higher RF power handling capability for a dielectric varactor.

Another advantage of dielectric varactors compared to diode varactors is the power consumption. The dissipation factor for a typical diode varactor is in the order of several hundred milliwatts, while that of the dielectric varactor is about 0.1 mW.

Diode varactors show high Q only at low microwave frequencies so their application is limited to low frequencies, while dielectric varactors show good Q factors up to millimeter wave region and beyond (up to 60 GHz).

Tunable dielectric varactors can also achieve a wider range of capacitance (from 0.1 pF all the way to several .mu.F), than is possible with diode varactors. In addition, the cost of dielectric varactors is less than diode varactors, because they can be made more cheaply.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

What is claimed is:

1. An apparatus, comprising:
a multi-tiered cascaded tunable dielectric phase shifter capable of operating in digital-analog regime by at least one cascade operable in an analog regime and at least one cascade operable in a digital regime.

2. The apparatus of claim 1, wherein said multi-tiered cascaded tunable dielectric phase shifter is a three tiered cascaded digital-analog phase shifter using broadside coupled lines with resonance terminations containing tunable dielectric film capacitors.

3. The apparatus of claim 2, wherein the first two cascades of said three tiered cascades is operable in a digital regime, and the third cascade is operable in an analog regime.

4. The apparatus of claim 3, wherein said digital regime operates at (0°/180° and 0°/90°) and said analog regime operates between (0°÷90°).

5. The apparatus of claim 3, wherein said analog cascade provides phase states from 0° up to φN−1 and adds the continuous phase shift functionality to the digital cascades of the phase shifter.

6. The apparatus of claim 1, wherein said tunable dielectric phase shifter is capable of providing a continuous 360° phase shift with 5% bandwidth and insertion loss of approximately 3 dB without modulation.

7. The apparatus of claim 1, wherein said tunable dielectric phase shifter is capable of a phase shift error of not more than Δφerror=±2° for all states of controlling voltages and has phase error that is equivalent to a 6-bit digital phase shifter.

8. The apparatus of claim 1, wherein a phase shift by said tunable dielectric phase shifter is enabled by one or more voltage tunable dielectric capacitors which comprises a low loss tunable dielectric material and metallic electrodes with predetermined shape, size, and distance.

9. A method, comprising:
operating a multi-tiered cascaded tunable dielectric phase shifter in the digital-analog regime by at least one cascade operable in an analog regime and at least one other cascade operable in a digital regime.

10. The method of claim 9, wherein said multi-tiered cascaded tunable dielectric phase shifter is a three tiered cascaded digital-analog phase shifter using broadside coupled lines with resonance terminations containing tunable dielectric film capacitors.

11. The method of claim 10, further comprising operating the first two cascades of said three tiered cascades in a digital regime, and operating the third cascade in an analog regime.

12. The method of claim 11, further comprising operating said digital regime at (0°/180° and 0°/90°) and said analog regime between (0°÷90°).

13. The method of claim 11, wherein said analog cascade provides phase states from 0° up to φN−1 and adds the continuous phase shift functionality to the digital cascades of the phase shifter.

14. The method of claim 9, wherein said tunable dielectric phase shifter is capable of providing a continuous 360° phase shift with 5% bandwidth and insertion loss of approximately 3 dB without modulation.

15. The method of claim 9, wherein said tunable dielectric phase shifter is capable of a phase shift error of not more than Δφerror=±2° for all states of controlling voltages and has phase error that is equivalent to a 6-bit digital phase shifter.

16. The method of claim 9, wherein a phase shift by said tunable dielectric phase shifter is enabled by one or more voltage tunable dielectric capacitors which comprises a low loss tunable dielectric material and metallic electrodes with predetermined shape, size, and distance.

17. A phase shifter, comprising:
broadside coupled lines with resonance terminations containing tunable dielectric film capacitors; and
at least one cascade within said phase shifter operable in an analog regime and at least two cascades operable in a digital regime.

19. The phase shifter of claim 17, wherein said at least two cascades operable in a digital regime operates at 0°/180° and 0°/90° and said analog regime operates between (0°÷90°).

20. The phase shifter of claim 17, wherein said phase shifter is capable of providing a continuous 360° phase shift with 5% bandwidth and insertion loss of approximately 3 dB without modulation.
